(19) United States
(12) Patent Application Publication
(10) Pub. No.: US 2004/0017911 A1
(43) Pub. Date: Jan. 29, 2004

(54) Line powered network element

(76) Inventor: Dieter H. Nattkemper, Raleigh, NC (US)

Correspondence Address: Fogg and Associates, LLC, P.O. Box 581339, Minneapolis, MN, 55458-1339, US

(21) Appl. No.: 10/449,259

(22) Filed: May 30, 2003

Related U.S. Application Data
(63) Continuation-in-part of application No. 10/134,323, filed on Apr. 29, 2002.

(51) Int. Cl. H04M 1/00; H04M 9/00

(52) U.S. Cl. 379/399.01; 379/413

(57) ABSTRACT

A method for controlling a line-powered network element in an access network is provided. The method includes provisioning at least one instance of a line power controller at the line-powered network element, provisioning at least one conductive medium associated with the at least one instance of the line power controller, receiving at least one primitive for use by the line power controller for managing the line-powered network element, monitoring at least one of the at least one primitive, and selectively taking action through the at least one line power controller based on the monitored ones of the at least one primitive in response to power conditions for the line-powered network element.

### CROSS REFERENCE TO RELATED APPLICATIONS

This application is related to co-pending application Ser. No. 10/134,323, filed on Apr. 29, 2002 and entitled MANAGING POWER IN A LINE POWERED NETWORK ELEMENT (the '323 Application). The '323 Application is incorporated herein by reference.

This application is also related to the following applications filed on even date herewith:

Application Ser. No. ______, entitled “FUNCTION FOR CONTROLLING LINE POWERING IN A NETWORK,” Attorney Docket No. 100.358US01 (the '358 Application).

Application Ser. No. ______, entitled “ELEMENT MANAGEMENT SYSTEM FOR MANAGING LINE-POWERED NETWORK ELEMENTS,” Attorney Docket No. 100.360US01 (the '360 Application).

Application Ser. No. ______, entitled “SPLITTER,” Attorney Docket No. 100.592US01 (the '592 Application).

The '358, '360 and '592 Applications are incorporated herein by reference.

### BACKGROUND

Telecommunications networks transport signals between user equipment at diverse locations. A telecommunications network includes a number of components. For example, a telecommunications network typically includes a number of switching elements that provide selective routing of signals between network elements. Additionally, telecommunications networks include communication media, e.g., twisted pair, fiber optic cable, coaxial cable or the like that transport the signals between switches. Further, some telecommunications networks include access networks.

For purposes of this specification, the term “access network” means a portion of a telecommunication network, e.g., the public switched telephone network (PSTN), that allows subscriber equipment or devices to connect to a core network. For purposes of this specification, the term access network further includes customer located equipment (CLE) even if commonly considered part of an enterprise network. Examples of conventional access networks include a cable plant and equipment normally located in a central office or outside plant cabinets that directly provides service interface to subscribers in a service area. The access network provides the interface between the subscriber service end points and the communication network that provides the given service. An access network typically includes a number of network elements.

A network element is a facility or the equipment in the access network that provides the service interfaces for the provisioned telecommunication services. A network element may be a stand-alone device or may be distributed among a number of devices. A network element is either central office located, outside plant located, or customer located equipment (CLE). Some network elements are hardened for outside plant environments. In some access networks as defined herein, various network elements may be owned by different entities. For example, the majority of the network elements in an access network may be owned by one of the Regional Bell Operating Companies (RBOCs) whereas the CLE may be owned by the subscriber. Such subscriber equipment is conventionally considered part of the subscriber's enterprise network, but, for purposes of this specification may be defined to part of the access network.

There are a number of conventional forms for access networks. For example, the digital loop carrier is an early form of access network. The conventional digital loop carrier transported signals to and from subscriber equipment using two network elements. At the core network side, a central office terminal is provided. The central office terminal is connected to the remote terminal over a high-speed digital link, e.g., a number of T1 lines or other appropriate high-speed digital transport medium. The remote terminal of the digital loop carrier typically connects to the subscriber over a conventional twisted pair drop.

The remote terminal of a digital loop carrier is often deployed deep in the customer service area. The remote terminal typically has line cards and other electronic circuits that need power to operate properly. In some applications, the remote terminal is powered locally. Unfortunately, to prevent failure of the remote terminal due to loss of local power, a local battery plant is typically used. This adds to the cost and complicates the maintainability of the remote terminal, due to the outside plant operational requirements which stipulate operation over extended temperature ranges.

In some networks, the remote terminal is fed power over a line from the central office. This is referred to as line feeding or line powering and can be accomplished through use of an AC or a DC source. Thus, if local power fails, the remote terminal still functions because it is typically powered over the line using a battery-backed power source. This allows the remote terminal to offer critical functions like lifeline plain old-fashioned telephone service (POTS) even during a power outage.

Over time, the variety of services offered over telecommunications networks has changed. Originally, the telecommunications networks were designed to carry narrowband, voice traffic. More recently, the networks have been modified to offer broadband services. These broadband services include services such as digital subscriber line (DSL) services. As time goes on, other broadband services will also be supported. These new services often come with increased power requirements.

As the service offerings have changed, the manner in which remote terminals are powered has not changed. The various services now offered are not all on equal footing. Data service today, unlike lifeline POTS, typically is not considered a necessity. Further, even among the other broadband services, there is a spectrum of variables affecting the level of service that a given subscriber wants and what the subscriber is willing to pay for it. Despite these changes in service offerings, the way that power is provided to the access equipment has not changed to keep pace with the service advancements.

Therefore, there is a need in the art for improvements in the manner in which power is provided to network elements in an access network.

### SUMMARY

Embodiments of the present invention address problems with providing power to network elements in an access network. Particularly, embodiments of the present invention provide power management for line powered network elements. Embodiments of the present invention provide a line power manager that runs on an element management system. The power manager provisions a power controller associated with the network element with at least one power criterion to use in controlling the operation of the network element based on a monitored power condition.

In one embodiment, a method for controlling a line-powered network element in an access network is provided. The method includes provisioning at least one instance of a line power controller at the line-powered network element, provisioning at least one conductive medium associated with the at least one instance of the line power controller, receiving at least one primitive for use by the line power controller for managing the line-powered network element, monitoring at least one of the at least one primitive, and selectively taking action through the at least one line power controller based on the monitored ones of the at least one primitive in response to power conditions for the line-powered network element.

### BRIEF DESCRIPTION OF THE DRAWINGS

FIG. 1 is a bock diagram of an embodiment of an access network with a power management application.

FIG. 2 is a block diagram of one embodiment of a power sourcing network element with a line power controller.

FIG. 3 is a flow chart of one embodiment of a process for provisioning a line power controller for a network element and for managing a line-powered network element with the power controller.

FIGS. 4 and 5 are flow charts of embodiments of output procedures for a network element.

FIG. 6 is a flow chart of one embodiment of a power control function for a network element according to the teachings of the present invention.

FIG. 7 is a flow chart of a process for storing primitives in a database for each power controller instance in a network element.

FIG. 8 is a graphical representation of a database for tracking primitives associated with instances of power controllers in a network element.

FIG. 9 is a block diagram of one embodiment of a power sinking network element with a power controller.

FIG. 10 is a flow chart of one embodiment of a process for a power controller for a subtended network element.

FIG. 11 is a flow chart of one embodiment of a power control function for a subtended network element.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide management of line powered network elements in an access network. A number of embodiments are described in detail below. As an overview, the various embodiments manage the operation of the line powered network elements based on selectable “primitives.” These primitives provide information and parameters that define a set of actions and criteria for managing services provisioned on the network element under various power conditions. For example, primitives define action or power criteria for managing the network element based on factors such as available power, power head-room, priority of services, or terms of service level agreements for various subscribers. A listing of examplary primitives is found in co-pending application Ser. No. ______ (the '358 Application).

In general, a line power manager establishes primitives for the managed network element and the provisioned services on the managed network element. A line power controller communicates with the power manager and uses the primitives to control the operation of the network element based on monitored power conditions of the network element. For example, the operation of the network element is selectively adjusted when power is lost or degraded, e.g., components of the network element are placed in low power mode, functions are disabled, or ports or services are selectively turned off.

Power based management of network elements provides many advantages in the operation of an access network. First, managed power results in higher efficiencies which permits an overall power savings. This translates into cost savings. Further, high power efficiency permits longer reach for a network element into the customer service area. Service intervals can also be scheduled or deferred for extended periods when power headroom is designed into power managed access networks. Also, power management can assure that priority services remain operational during element faults and battery plant faults, e.g., through use of a controlled service shut down based on priority of service and timed events. Finally, power management at the network element allows flexibility in creating differentiated services. For example, a selected data service at a moderate priority level may be provisioned to operate for a selected period of time when a power failure causes a switch over to a battery back-up power source.

A number of embodiments are described below. Section I gives an overview of one embodiment of a power management scheme. Section II describes one embodiment of a power controller for a power sourcing network element. Finally, section III describes one embodiment of a power controller for a subtended, power sinking network element. The '360 Application describes one embodiment of an element management system that is adapted to operate with the network elements described herein to implement the power management scheme.

### I. Overview

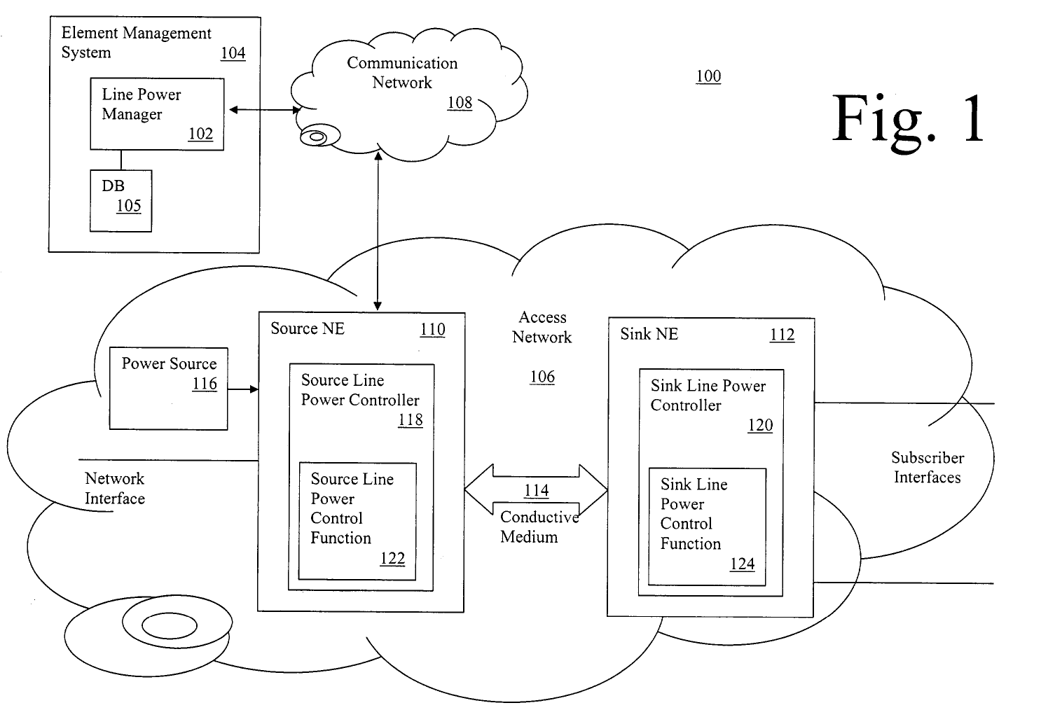

FIG. 1 is a block diagram of an embodiment of a system, indicated generally at 100, that provides power management for line-powered network elements within access network 106 using a power management application running on element management system (EMS) 104. The power management application, in one embodiment, instantiates line power managers, represented by line power manager 102 of FIG. 1, to manage power for the line-powered network element. In one embodiment, line power manager 102 manages network elements, e.g., power sourcing network element (Source NE) 110 and power sinking network element (Sink NE) 112, through one or more power controllers, e.g., source line power controller 118 and sink line power controller 120, based on one or more primitives. In one embodiment, Sink NE 112 is a Remote Terminal (RT) and Source NE 110 is a Central Office Terminal (COT) in a line-powered, digital loop carrier system. In other embodiments, Sink NE 112 is customer premises equipment (CPE) such as a DSL modem, integrated access device, or other network element conventionally considered as part of an enterprise network. In general, Sink NE 112 provides an interface to subscriber equipment and Source NE 110 provides an interface to a network, e.g., a data network such as the Internet. Source NE 110 provides power to Sink NE 112 over conductive medium 114. In one embodiment, conductive medium 114 comprises one or more conductive cables, e.g., one or more twisted pair telephone lines, coaxial cables, or other appropriate conductive medium. In one embodiment, conductive medium 114 carries communication signals in addition to power signals between Source NE 110 and Sink NE 112.

The power management application includes machine-readable instructions stored on a machine-readable medium for running on a programmable processor of EMS 104 to implement a method for power manager 102. For purposes of this specification, a “machine-readable medium” includes, but is not limited to, random access memory (DRAM, SRAM), Flash memory, read only memory (ROM), electrically erasable programmable read only memory (EEPROM), optical or magnetic based storage medium, or other appropriate storage medium. Further, for purposes of this specification, an element management system is a system with functions that are adapted to provide administration for one or more access networks and a plethora of network elements in the access network, e.g., a central office terminal, a remote terminal, customer premises equipment, etc. The functions of an EMS include provisioning, status performance monitoring, alarming for critical functions, report generation, statistics charting and many other functions. The man-machine interface for EMS 104 typically comprises a graphical user interface. In one embodiment, EMS 104 supports multiple instantiations of line power manager 102. Each of the instantiations implements the same or different types of power management functions.

Line power manager 102 establishes a set of primitives for controlling services provided by a network element, e.g., Source NE 110 and Sink NE 112, based on power conditions. Further, line power manager 102 manages the provisioned primitives in an associated database (DB) 105 such as described in co-pending application Ser. No. 10/134,323, filed on Apr. 29, 2002 and entitled MANAGING POWER IN A LINE POWERED NETWORK ELEMENT (the '323 Application). The '323 Application is incorporated herein by reference. In one embodiment, database 105 maintains a listing of all primitives assigned to all network elements in access network 106. Further, each network element maintains a subset of database 105 for the primitives associated with the network element.

Line power manager 102 communicates with source line power controller 118 and sink line power controller 120 over an appropriate management interface, e.g., communication network 108. This management interface is accomplished with any known or later developed management interface, e.g., SNMP or other appropriate management interface. In one embodiment, line power manager 102 communicates with source line power controller 118 and sink line power controller 120 as defined in a management information base (MIB) for the power management application.

In one embodiment, source line power controller 118 and sink line power controller 120 are implemented as machine readable instructions stored on a machine readable medium and run on an embedded processor. Further, in one embodiment, power management at the Source NE 110 is implemented through source line power controller 118 in combination with one or more source line power control functions 122. Similarly, power management at the Sink NE 112 is implemented through sink line power controller 120 in combination with one or more sink line power control functions 124. In one embodiment, source line power control functions 122 and sink line power control functions 124 are implemented as described in the '358 Application.

Power is provided to Source NE 110 and Sink NE 112 from one or more of power sources 116. The possible locations of the power source with respect to access network 106 and the line-powered network elements is described in detail in the '323 Application which application is incorporated herein by reference.

Source NE 110 and Sink NE 112 are coupled together over conductive medium 114. In one embodiment, conductive medium 114 comprises one or more communication lines, e.g., copper cables, twisted pair, etc. In one embodiment, conductive medium 114 transports both power and communication signals between Source NE 110 and Sink NE 112. In one embodiment, conductive medium 114 comprises a number of links. Each link is adapted to carry both power and communication signals. Conductive medium 114, in one embodiment, comprises a power interface for transporting power between Source NE 110 and Sink NE 112, a management communication interface for carrying management information, e.g., primitives, between Source NE 110 and Sink NE 112, and a digital communication interface for providing communications signals between Source NE 110 and Sink NE 112.

In operation, line power manager 102 manages the operation of Source NE 110 and Sink NE 112 based on one or more primitives stored in database 105 to provide managed power from Source NE 110 to Sink NE 112. Line power manager 102 selects and provides the one or more primitives to source line power controller 118 and sink line power controller 120. Source line power controller 118 and sink line power controller 120 are selectively associated with conductive medium 114 to provide power from Source NE 110 to Sink NE 112.

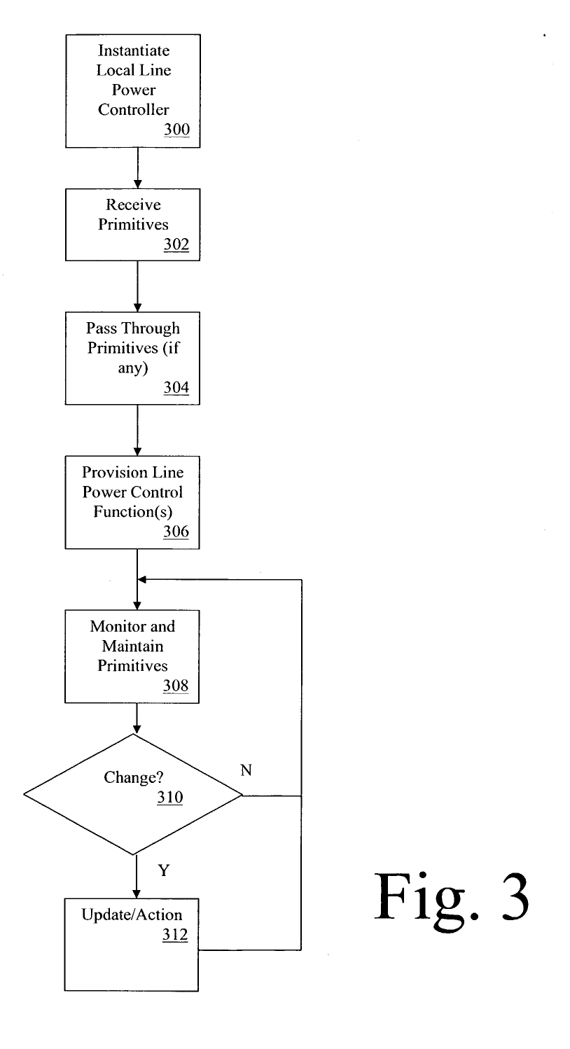

In one embodiment, line power manager 102 establishes the at least one power criterion as part of a “flow through” provisioning for a service provided at Sink NE 112. In one embodiment, line power manager 102 establishes the at least one power criterion either through explicit or implicit selection (also called “flow through” provisioning elsewhere herein) as described with respect to FIG. 3 of the '360 Application.

The provisioned line power controllers, e.g., source line power controller 118 and sink line power controller 120, monitor the operation of Source NE 110 and Sink NE 112, respectively, through the provisioned primitives. If power fails or degrades, the source line power controller 118 and the sink power controller 120 detect and report the power condition using appropriate primitives and make any necessary adjustments to the operation of Source NE 110 and Sink NE 112 based on the current power conditions. For example, in one embodiment, sink line power controller 120 shuts down services according to a priority scheme until the appropriate power consumption level is achieved when power available at Sink NE 112 is degraded. Any appropriate priority scheme can be used. For example, priority based on service type, port number, service level agreements, random, or other appropriate scheme. In other embodiments, sink line power controller 120 places components Sink NE 112 in low power mode. The use of low power mode can also be implemented according to a priority scheme.

### II. Power Sourcing Network Element

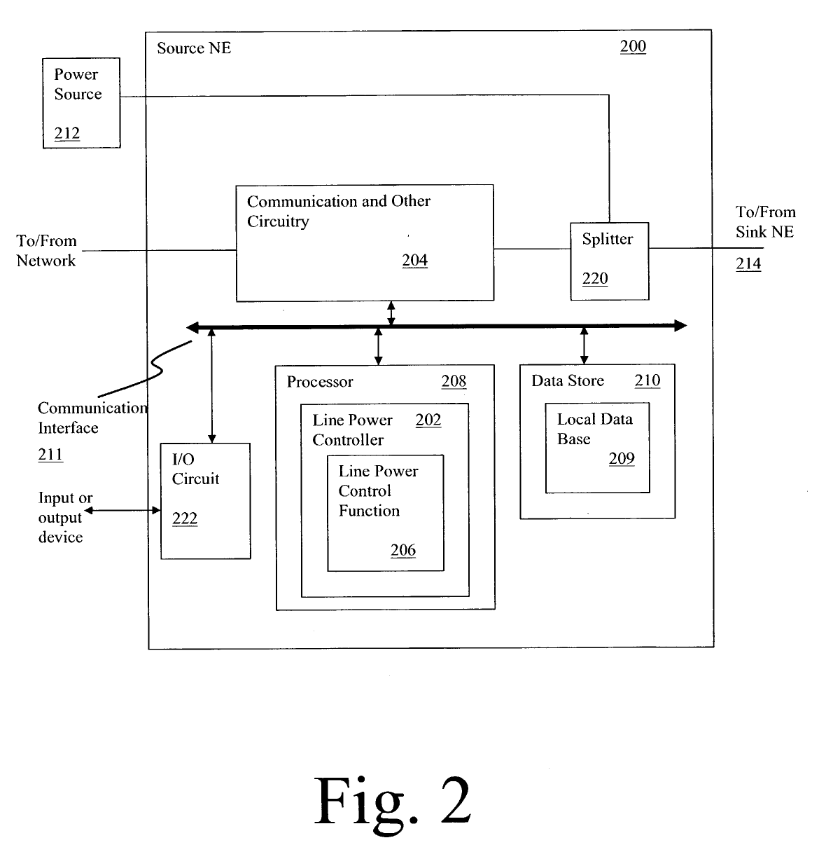

FIG. 2 is a block diagram of one embodiment of a power sourcing network element (Source NE), indicated generally at 200, including line power controller 202. Source NE 200, in one embodiment, comprises a central office terminal (COT) that provides line power to a line-powered network element, e.g., a line-powered remote terminal, line-powered customer located equipment, or other appropriate line-powered equipment. Line power controller 202 provides local management functions and line power control. Source NE 200 is defined as a type of communications equipment device that is housed in some type of cabinet or in a central office. With respect to an element management system, such as EMS 104 of FIG. 1, Source NE 200 is a network element of an access network.

Source NE 200 communicates signals between a network interface and one or more subtended, line-powered network elements through splitter 220. The communication and other basic functions of Source NE 200 are accomplished in communication and other circuitry 204 as is known in the art. In one embodiment, circuitry 204 supports one or more communication protocols such as asymmetric digital subscriber line (ADSL), G.SHDSL, VDSL, and other appropriate communication protocols.

Source NE 200 is coupled to power source 212. In one embodiment, power source 212 comprises an AC power supply. In other embodiments power source 212 comprises a DC power supply. In further embodiments, power source 212 comprises an AC power supply with a battery plant or other back-up power supply.

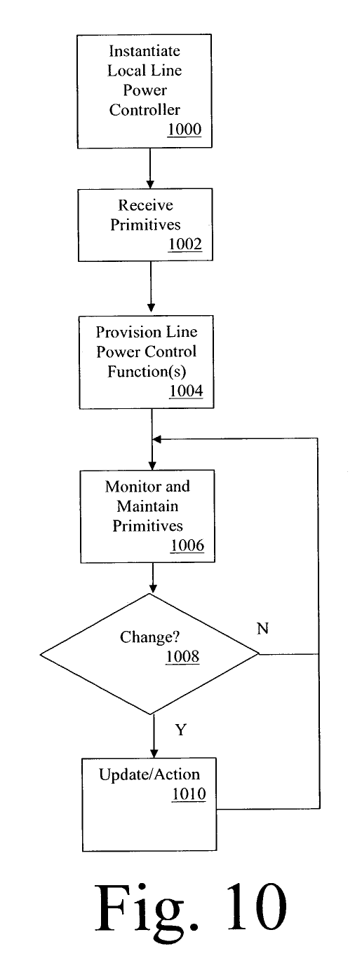

Power source 212 provides power for Source NE 200 and a subtended, line powered network element (Sink NE) such as a remote terminal of a digital loop carrier or customer located equipment such as a DSL modem or integrated access device. One embodiment of a Sink NE is described below with respect to FIGS. 9-11. Power from power source 212 is provided to an input of splitter 220. Splitter 220 combines the communications signals from circuitry 204 with the power from power source 212. In one embodiment, splitter 220 is constructed as described in the '592 Application.

The combined signal is provided to the subtended Sink NE over link 214. In one embodiment, link 214 carries both power and communication signals between Source NE 200 and the subtended Sink NE over, for example, a conductive medium such as a copper cable, twisted pair or the like. In one embodiment, link 214 comprises one or more links. The use of multiple links for carrying power provides advantages when implementing power management of a Sink NE, e.g., a line-powered remote terminal, customer premises equipmemt. For example, when multiple links are used and a link is damaged or otherwise is not capable of delivering full power, power can be delivered over any one or more of the remaining links.

Line power controller 202 manages operation of Source NE 200 based on power conditions. Line power controller 202 includes a number of functions, represented by line power control function 206, that run on programmable processor 208 to implement the management of Source NE 200 based on power conditions. In one embodiment, line power control function 206 is implemented as described in the '358 Application. In one embodiment, the functions used by processor 208 are stored as a plurality of procedures or programs with machine readable instructions stored in a machine readable medium, for example, non-volatile memory of data store 210. In one embodiment, data store 210 comprises one or more of a magnetic storage medium such as a disk drive, dynamic random access memory (DRAM, SRAM), Flash memory, read only memory (ROM), electrically erasable programmable read only memory (EEPROM), or other appropriate storage medium.

Line power controller 202 and line power control functions 206, running on processor 208, monitors power conditions and controls operation of the Source NE 200 based on a number of primitives established for each instance of the line power control functions running on processor 208. The association between the primitives and the instance of the line power control functions is established and maintained in database 209 in data store 210. The selection of primitives for each instance of the line power controller is accomplished, in one embodiment, in an element management system such as the system described in the '360 Application.

The various elements of Source NE 200 are coupled together over communication interface 211. Further, Source NE 200 includes an input/output circuit (I/O) 222 that provides an interface to an input/output device such as a craft port, display, keyboard, mouse, touch screen or other appropriate input/output device. In one embodiment, communication interface 211 comprises one or more busses for carrying signals between the various components of Source NE 200. In one embodiment, communication interface 211 is coupled to processor 208, data store 210, I/O circuit 222, and communication circuitry 204.

FIGS. 3-8 describe various embodiments of functions performed by a Source NE in the management of a line-powered NE.

FIG. 3 is a flow chart of one embodiment of a process for provisioning a line power controller for a source network element (Source NE) and for managing a line-powered network element with the line power controller. The process begins at block 300 and instantiates the local line power controller, e.g., line power controller 202 of FIG. 2. For purposes of this specification, a single instance of the line power controller is described. It is understood, however, that in normal operation of the Source NE, many instances of the line power controller run simultaneously on a processor, such as processor 208 of FIG. 2, to control the various services provisioned in the line powered network element or elements.

The process controls operation of the network element based on one or more sets of primitives based on power conditions. At block 302, the process receives one or more sets of primitives. In one embodiment, the primitives are received from a power management application running on an element management system such as described with respect to FIG. 1, above, and in the '360 Application. In one embodiment, these primitives include a set of primitives that define an interface between the power management application running on the element management system and the line power controller. The process further associates the primitives with the instance of the line power controller in a database, such as database 209 of FIG. 2, so as to allow the process to manage the primitives used in the various instances of the line power controller. At block 304, the process passes through primitives, if any, that are to be used in a subtended network element, e.g., a subtended power sink, a line-powered remote terminal, a line-powered modem, a line-powered integrated access device, or other appropriate line-powered network element. This pass through function establishes an interface between the power management application at the element management system and line power control functions at the subtended network element. This interface is used to transfer primitives to manage and control each line power controller instance in the subtended network element.

Using the primitives, the process monitors and controls the network element. At block 306, the process provisions one or more line power control functions for use in monitoring and controlling the operation of the network element. In one embodiment, the line power control function is provisioned with power save switching functions that degrade or turn off services based on a specified priority or other specified basis. An example of one such control function is described below with respect to FIG. 5. At block 308, the process monitors and maintains information on the power conditions affecting the network element. This information is monitored using the provisioned primitives and control functions. In one embodiment, the provisioned primitives include a set of primitives that define an interface between the line power controller and the line power control function.

Further, this information is passed back, as necessary, to a power management application running on an element management system for use in displaying alarms and other information. Further, when a change is detected at block 310, the monitored data is updated and any appropriate action is taken. For example, in one embodiment, power save functions are invoked that turn off or degrade selected services or functions. Alternatively, protection switching functions can also be invoked. The process then returns to block 308 and continues to monitor the power condition at the network element.

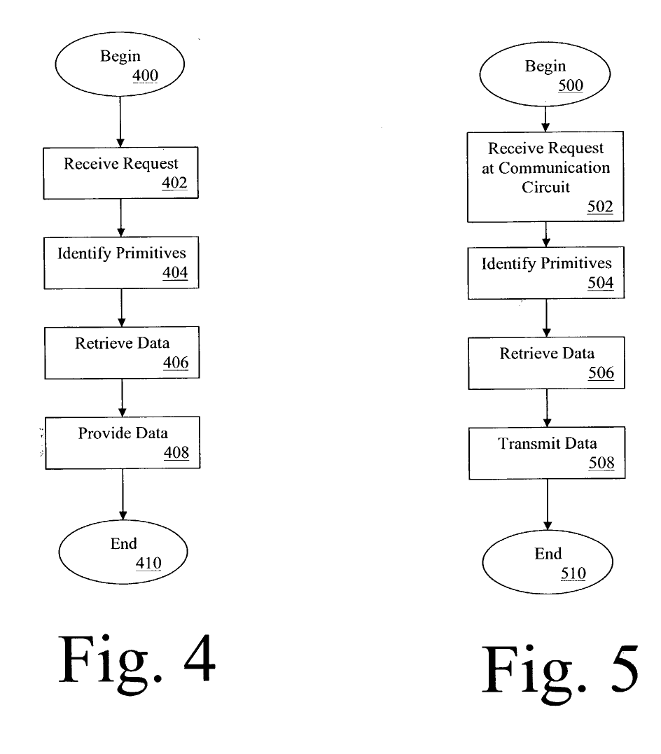

FIGS. 4 and 5 are flow charts of embodiments of output procedures for a network element. Each instance of the line power controller 202 monitors various conditions of the managed, line-powered network element based on the provisioned primitives. The power controller 202 thus receives status and alarm data from the line-powered network element through the provisioned primitives. The power controller 202 provides access for a user to this data in at least two ways. First, the power controller 202 provides access to the data through a craft port coupled to I/O circuit 222. Data is retrieved from the craft port using a procedure shown in FIG. 4. Further, data is also provided to a user at a remote monitoring station over a network connection using the process shown in FIG. 5.

The process for providing data to a craft port begins at block 400 of FIG. 4. At block 402, the process receives a request to display data for a monitored line-powered network element. At block 404, the process identifies the primitives associated with the line-powered network element. At block 406, the process retrieves data from database 209 that indicates the current conditions being monitored at the line-powered network element. At block 408, the process provides the data to the craft port on I/O circuit 212 for display to the user. The process ends at 410. In one embodiment, the process further updates the data displayed at the craft port when the monitored data changes values.

The process for providing data to a remote monitoring station begins at block 500 of FIG. 5. At block 502, the process receives a request from a remote monitoring station. At block 504, the process identifies the primitives associated with the line-powered network element. At block 506, the process retrieves data from database 209 that indicates the current conditions being monitored at the line-powered network element. At block 508, the process provides the data to the remote monitoring station for display to the user. The process ends at 510. In one embodiment, the process further updates the data displayed at the remote monitoring station when the monitored data changes values.

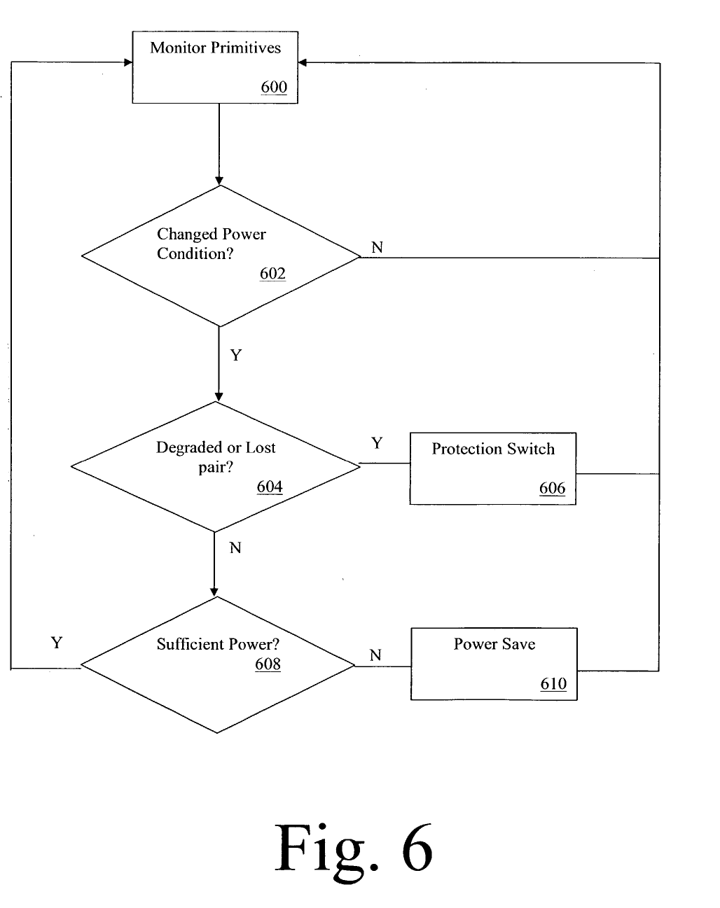

FIG. 6 is a flow chart of one embodiment of a power control function for a network element according to the teachings of the present invention. The method begins at block 600. The method monitors a set of primitives associated with the power control function, e.g., primitives provided by the line power management application running on an element management system when the power control function is initialized. At 602, the method determines from the monitored primitives when a changed power condition exists. At block 604, the method further determines whether power delivered over one or more lines is degraded or lost. If so, the method performs protection switching at block 606 so that power is provided over an available line. For example, in one embodiment, a remote terminal is subtended from a central office terminal over five T1 lines. Power is provided over to the remote terminal over two of the T1 lines. When power is lost or degraded over one of the two lines, the process switches to deliver power over another one of the five lines in place of the problem line. In one embodiment, this protection switching further involves determining whether the line to be used to carry power and carry a communication service that would interfere with the providing power over the line. If so, the service is either moved to a different line or suspended during the time power is provided over the line.

At block 608, the method determines whether there is sufficient power available. This determination is based on the primitives provisioned for the Source NE. For example, the method determines that there is insufficient power if the power available to the Source NE does not exceed the power required to provide services as currently configured. Further, in other embodiments, the method determines whether there is insufficient power based on other conditions such as the use of battery power versus line power and the like. Additionally, in other embodiments, the method uses other conditions monitored by the primitives to determine that there is not sufficient power to maintain the current operation of the Source NE. If there is sufficient power, the method returns to block 600 and continues to monitor primitives for changes in power conditions. If there is not sufficient power, as defined above, one or more power save functions is invoked at block 610. For example, various components in the central office terminal are placed in a power save mode to reduce the required power below the level of available power.

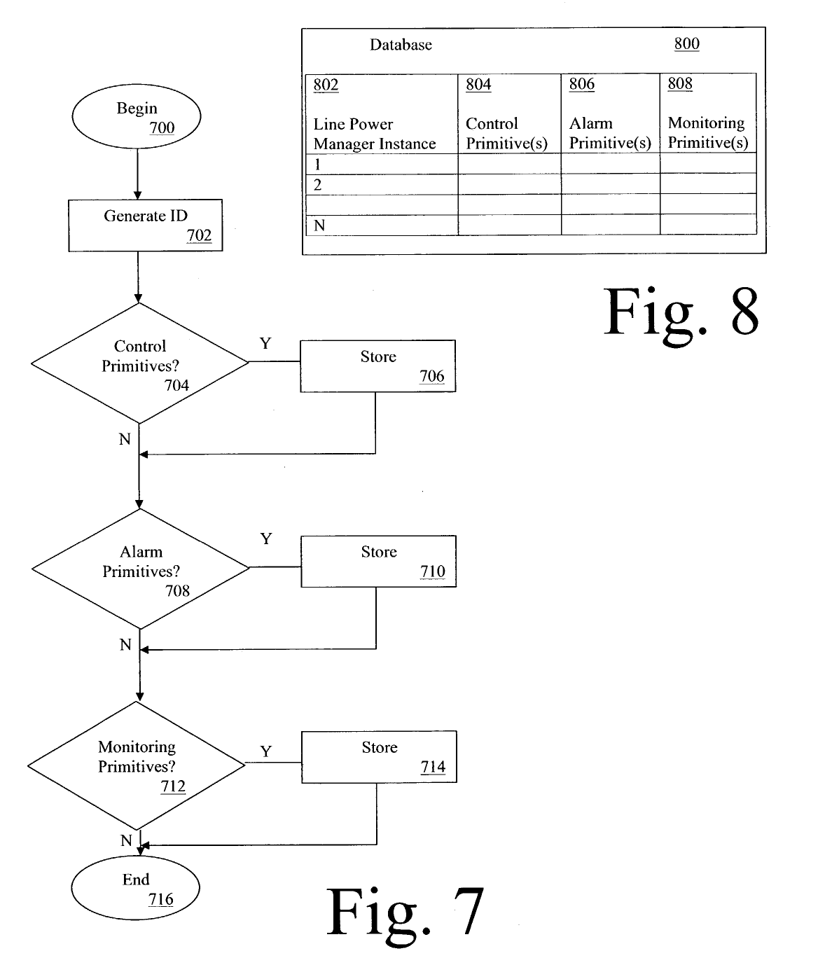

FIG. 7 is a flow chart of a process for storing primitives in a database for each line power controller instance in Source NE 200. These primitives are received from the element management system, e.g., the element management system of the '360 Application, at the time the line power controller is instantiated. This process provides a mechanism for the local Source NE to manage the primitives for each line power controller instance running on its processor.

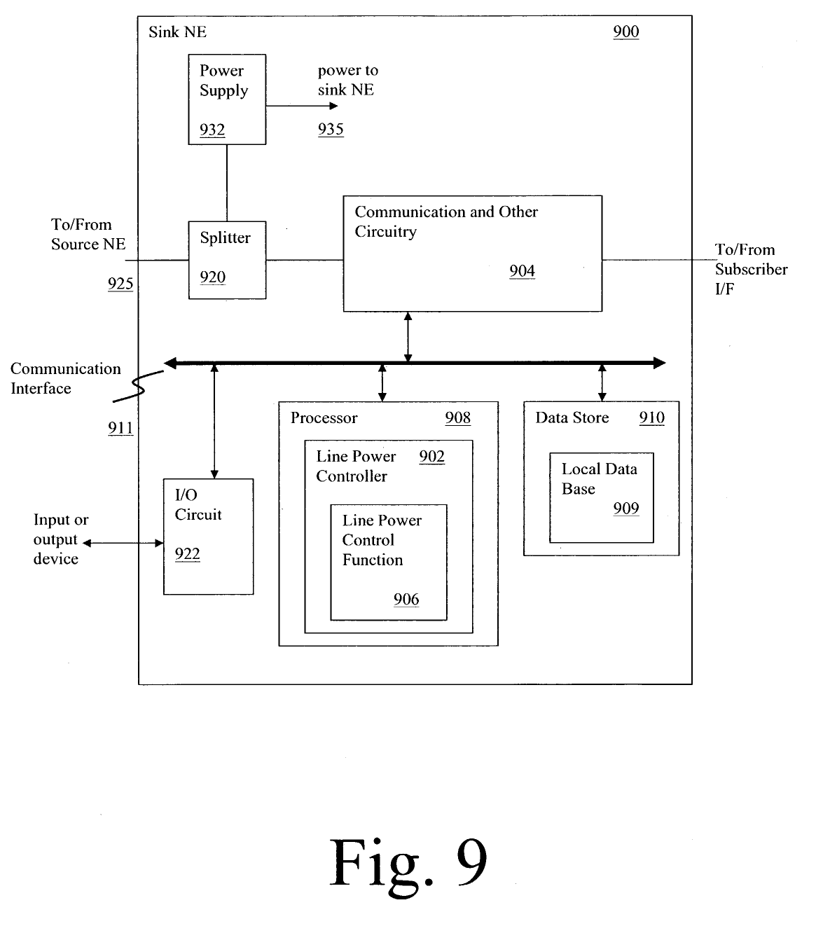

The process begins at block 700. At block 702, an identifier (ID) for the line power controller instance is generated. This identifier is stored in a database such as column 802 of database 800 of FIG. 8. Once the identifier is generated, the primitives are stored in data base 800. At block 704, the process determines if there are any control primitives associated with the line power manager instance. If so, the control primitives are stored at block 706 in column 804 in the row associated with the line power manager instance. If not, the process proceeds to block 708. At block 708, the process determines if there are any alarm primitives associated with the line power manager instance. If so, the alarm primitives are stored at block 710 in column 806 in the row associated with the line power manager instance. If not, the process proceeds to block 712. At block 712, the process determines if there are any monitoring primitives associated with the line power manager instance. If so, the monitoring primitives are stored at block 714 in column 808 in the row associated with the line power manager instance. If not, the process ends at block 816. In other embodiments, the primitives are stored as they are received and are stored in the appropriate location in database 800 based on the type of primitive and the line power controller instance.

### III. Power Sinking Network Element

FIG. 9 is a block diagram of one embodiment of a power sinking network element (Sink NE), indicated generally at 900, with a line power controller 902. Line power controller 902 provides local management functions and line power control for Sink NE 900. In one embodiment, Sink NE 900 comprises communications equipment that is housed in some type of cabinet, pedestal, or other outside plant enclosure. With respect to an element management system, such as EMS 104 of FIG. 1, Sink NE 900 is a network element of an access network or customer located equipment of an enterprise network.

Sink NE 900 communicates signals between a Source NE and one or more subscriber interfaces. The communication and other basic functions of Sink NE 900 are accomplished in communication and other circuitry 904 as is known in the art. In one embodiment, circuitry 204 supports one or more communication protocols such as asymmetric digital subscriber line (ADSL), G.SHDSL, VDSL, and other appropriate communication protocols.

Sink NE 900 is line powered. In one embodiment, power is provided to Sink NE 900 over one or more links 925 coupled between Sink NE 900 and its Source NE, e.g., Source NE 200 of FIG. 2. In one embodiment, power is supplied from an AC power supply. In other embodiments power is supplied from a DC power supply. In further embodiments, power is supplied from an AC power supply with a battery plant or other back-up power supply.

Link 925 receives power for the operation of Sink NE 900. In one embodiment, link 925 carries both power and communication signals between a central office terminal and Sink NE 900 over, for example, a conductive medium such as a copper cable, twisted pair or the like. In one embodiment, link 925 comprises one or more links. The use of multiple links for carrying power provides advantages when implementing power management of a Sink NE, e.g., a line-powered remote terminal, customer premises equipment or the like. For example, when multiple links are used and a link is damaged or otherwise is not capable of delivering the primitive specified amount of power, power can be delivered over any one or more of the remaining links. The power and communication signals supplied on link 925 are provided to an input of splitter 930. In one embodiment, splitter 930 is constructed as described in the '592 Application. Splitter 930 separates the power signal from the communication signals. Splitter 930 provides the power signal to local power supply 932 to provide power for Sink NE 900 at output 935 of power supply 932. Output 935 provides power, for example, to processor 908, data store 910, communication and other circuitry 904, and I/O circuit 922. Further, splitter 930 provides the communications signals to communication and other circuitry 904.

Line power controller 902 manages operation of Sink NE 900 based on power conditions. Line power controller 902 includes a number of functions, represented by line power control function 906, that run on programmable processor 908 to implement the management of Sink NE 900 based on power conditions. In one embodiment, line power control function 906 is implemented as described in the '358 Application. In one embodiment, the functions used by processor 908 are stored as a plurality of procedures or programs with machine readable instructions stored in a machine readable medium, for example, non-volatile memory of data store 910. In one embodiment, data store 910 comprises one or more of a magnetic storage medium such as a disk drive, dynamic random access memory (DRAM, SRAM), Flash memory, read only memory (ROM), electrically erasable programmable read only memory (EEPROM), or other appropriate storage medium.

Line power controller 902 and line power control functions 906, running on processor 908, monitors power conditions and controls operation of the Sink NE 900 based on a number of primitives established for each instance of the line power control functions running on processor 908. The association between the primitives and the instance of the line power control functions is established and maintained in database 909 in data store 910. The selection of primitives for each instance of the line power controller is accomplished, in one embodiment, in an element management system such as the system described in the '360 Application.

The various elements of Sink NE 900 are coupled together over communication interface 911. Further, Sink NE 900 includes an input/output circuit (I/O) 922 that provides an interface to an input/output device such as a craft port, display, keyboard, mouse, touch screen or other appropriate input/output device. In one embodiment, communication interface 911 comprises one or more busses for carrying signals between the various components of Sink NE 900. In one embodiment, communication interface 911 is coupled to processor 908, data store 910, I/O circuit 922, and communication circuitry 904.

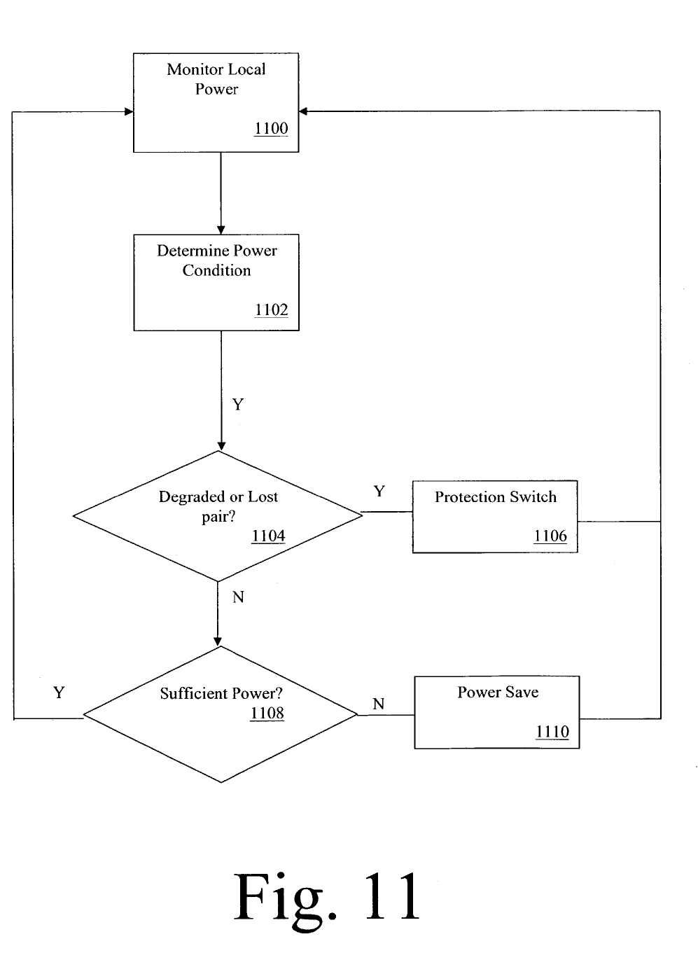

FIGS. 10 and 11 describe various embodiments of functions used to provide power management for Sink NE 900. In one embodiment, NE Sink 900 supports the processes of FIGS. 4 and 5 for reading monitored data out of NE Sink 900. Further, in one embodiment, the process of FIG. 7 and the database of FIG. 8 are implemented in NE Sink 900 to provide local storage of the primitives associated with each instance of the line powered network element.

FIG. 10 is a flow chart of one embodiment of a process for a line power controller for a subtended network element such as line power controller 902 of FIG. 9. The process begins at block 1000 and instantiates the local line power controller, e.g., line power controller 902 of FIG. 9. For purposes of this specification, a single instance of the line power controller is described. It is understood, however, that in normal operation of the Sink NE, many instances of the line power controller run simultaneously on a processor, such as processor 908 of FIG. 9, to control the various services provisioned in the line powered network element or elements.

The process controls operation of the network element based on one or more sets of primitives based on power conditions. At block 1002, the process receives one or more sets of primitives. In one embodiment, the primitives are received as pass through primitives from a central office terminal. In other embodiments, the primitives are received directly from a power management application running on an element management system such as described above with respect to FIG. 1 and in the '360 Application. In one embodiment, these primitives include a set of primitives that define an interface between the power management application running on the element management system and the line power controller. The process further associates the primitives with the instance of the line power controller in a database, such as database 909 of FIG. 9, so as to allow the process to manage the primitives used in the various instances of the line power controller.

Using the primitives, the process monitors and controls the network element. At block 1004, the process provisions one or more line power control functions for use in monitoring and controlling the operation of the network element. In one embodiment, the line power control function is provisioned with power save switching functions that degrade or turn off services based on a specified priority or other specified basis. An example of one such control function is described below with respect to FIG. 11. At block 1006, the process monitors and maintains information on the power conditions affecting the network element. This information is monitored using the provisioned primitives and control functions. In one embodiment, the provisioned primitives include a set of primitives that define an interface between the line power controller and the line power control function.

Further, this information is passed back, as necessary, to a power management application running on an element management system for use in displaying alarms and other information. Further, when a change is detected at block 1008, the monitored data is updated and any appropriate action is taken at block 1010. For example, in one embodiment, power save functions are invoked that turn off or degrade selected services or functions. Alternatively, protection switching functions can also be invoked. The process then returns to block 1006 and continues to monitor the power condition at the network element.

FIG. 11 is a flow chart of one embodiment of a power control function for a network element according to the teachings of the present invention. The method begins at block 1100. The method monitors a set of primitives associated with the power control function, e.g., primitives provided by the line power management application running on an element management system when the power control function is initialized. In one embodiment, these primitives include state of the battery plant and the state of AC input at the power supply provided to the subtended Sink NE. At 1102, the method determines the current power condition at the Sink NE. For example, the method determines the power condition based on power performance parameters and statistics using threshold or power head-room calculations. Various measurement techniques are available to accomplish this monitoring of the current power conditions. For example, in one embodiment, a direct power calculation is used based on a percent of power used, the number of Watts used relative to total available Watts, and the number of provisioned lines available to deliver power. In other embodiments, a power head-room calculation is used in which an iterative power head-room estimation is calculated. To generate a meaningful measure of the available power, the Sink NE also includes power control interface techniques that provide predictable power consumption behavior for the circuitry of the Sink NE. Thus, the power calculations provide a basis for determining whether action needs to be taken based on the current power condition.

At block 1104, the method further determines whether power delivered over one or more lines is degraded or lost. If so, the method performs protection switching at block 1106 so that power is provided over available lines. For example, in one embodiment, a remote terminal is subtended from a central office terminal over five T1 lines. Power is provided to the remote terminal over two of the T1 lines. When power is lost or degraded over one of the two lines, the process switches to deliver power over another one of the five lines in place of the problem line. In one embodiment, this protection switching further involves determining whether the line to be used to carry power was carry a communication service that would interfere with the providing power over the line. If so, the service is either moved to a different line or suspended during the time power is provided over the line.

At block 1108, the method determines whether there is sufficient power available. This determination is based on the primitives provisioned for the Sink NE. For example, the method determines that there is insufficient power if the power available to the Sink NE does not exceed the power required to provide services as currently configured. Further, in other embodiments, the method determines whether there is insufficient power based on other conditions such as the use of battery power versus line power and the like. Additionally, in other embodiments, the method uses other conditions monitored by the primitives to determine that there is not sufficient power to maintain the current operation of the Sink NE. If there is sufficient power, the method returns to block 1100 and continues to monitor primitives for changes in power conditions. If there is not sufficient power, as defined above, one or more power save functions is invoked at block 1110. For example, in one embodiment, various components in the Sink NE are placed in a power save mode to reduce the required power below the level of available power. Further, in other embodiments, selective power down of services is provided. In this case, services offered at the Sink NE are selectively degraded or turned off based on the provisioned primitives and the current power condition. Thus, for example, lower priority services, e.g., data, are turned off first when the total power available falls below a selected level while higher priority services, e.g., POTS, are unaffected. Similarly, lower priority services are selectively turned off when AC power is lost and power is provided from a back-up battery source.

Although the processes shown in FIGS. 3-7, 10 and 11 are depicted as sequential steps, this functionality can be implemented in many ways using conventional or later developed programming techniques. Further, the processes and techniques described here may be implemented in digital electronic circuitry, or with a programmable processor (for example, a special-purpose processor or a general-purpose process such as a computer), firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the scope of the claimed invention. Accordingly, other embodiments are within the scope of the following claims.

What is claimed is:

1. A method for controlling a line-powered network element in an access network, the method comprising:
provisioning at least one instance of a line power controller at the line-powered network element;
provisioning at least one conductive medium associated with the at least one instance of the line power controller;
receiving at least one primitive for use by the line power controller for managing the line-powered network element;
provisioning at least one line power control function associated with the at least one instance of the line power controller;
monitoring at least one of the at least one primitive; and
selectively taking action through the at least one line power control function based on the monitored ones of the at least one primitive in response to power conditions for the line-powered network element.

2. The method of claim 1, wherein receiving at least one primitive comprises receiving the at least one primitive from a source network element as a pass through from an element management system.

3. The method of claim 1, wherein receiving at least one primitive comprises receiving a set of primitives that define an interface between a power management application running on an element management system and the line power controller.

4. The method of claim 1, wherein receiving at least one primitive comprises receiving a set of primitives that define an interface between the line power controller and the at least one line power control function.

5. The method of claim 1, wherein selectively taking action comprises invoking one or more power save and protection switching functions.

6. The method of claim 1, wherein provisioning at least one conductive medium with the at least one instance of the line power controller comprises associating at least one conductive medium that also transports communication signals.

7. The method of claim 1, wherein provisioning at least one conductive medium with the at least one instance of the line power controller comprises associating at least one conductive medium with at least one media interface.

8. A source network element in an access network for providing line power to a subtended, sink network element, the source network element comprising:
communication circuitry for providing communication signals to and from the subtended sink network element over one or more communication links and for providing line powering to the subtended, sink network element; and
a processor, coupled to the communication circuitry, the processor adapted to instantiate a line power controller based on services provisioned at the subtended sink network element, the line power controller adapted to monitor and control the power consumption of the source network element and the sink network element based on at least one provisioned primitive, the line power controller associated with at least one conductive medium for carrying power between the source network element and the sink network element.

9. The source network element of claim 8, wherein the line power controller is adapted to invoke power save functions based on the at least one provisioned primitive.

10. The source network element of claim 8, further including a data store, the data store having a database of primitives, and wherein the line power controller maintains the database of primitives for the source network element.

11. The source network element of claim 8, wherein the line power controller provisions at least one line power control function for monitoring and controlling the power consumption at the source network element.

12. The source network element of claim 8, further including a splitter coupled to the output of the communication circuitry, the splitter adapted to allow a power signal to be transmitted on the same link with the communication signals.

13. The source network element of claim 8, wherein the line power controller is associated with at least one conductive medium with at least one media interface.

14. A sink network element that is subtended from a source network element and receives line power from the source network element in an access network, the sink network element comprising:
communication circuitry for providing communication signals between the source network element and a number of subscriber interfaces; and
a processor, coupled to the communication circuitry, the processor adapted to instantiate a line power controller based on services provisioned at the sink network element, the line power controller adapted to monitor and control the power consumption of the sink network element based on at least one provisioned primitive, the line power controller associated with at least one conductive medium for carrying power between the source network element and the sink network element.

15. The sink network element of claim 14, wherein the line power controller is adapted to invoke power save functions based on the at least one provisioned primitive.

16. The sink network element of claim 14, further including a data store, the data store having a database of primitives, and wherein the line power controller maintains the database of primitives for the sink network element.

17. The sink network element of claim 14, wherein the line power controller provisions at least one line power control function for monitoring and controlling the power consumption at the sink network element.

18. The sink network element of claim 17, wherein the at least one line power control function comprises a function that disables or degrades services provisioned on the sink network element based on the at least one provisioned primitive.

19. The sink network element of claim 14, further including a splitter coupled to an input of the communication circuitry, the splitter adapted to allow a power signal to be received on the same link with the communication signals.

20. The sink network element of claim 14, wherein the line power controller is associated with at least one conductive medium with at least one media interface.

21. Apparatus comprising a storage medium tangibly embodying program instructions for controlling a line-powered network element in an access network, the program instructions including instructions operable to cause at least one programmable processor to execute a method comprising:
provisioning at least one instance of a line power controller at the line-powered network element;
provisioning at least one conductive medium associated with the at least one instance of the line power controller;
receiving at least one primitive for use by the line power controller for managing the line-powered network element;
provisioning at least one line power control function associated with the at least one instance of the line power controller;
monitoring at least one of the at least one primitive; and
selectively taking action through the at least one line power control function based on the monitored ones of the at least one primitive in response to power conditions for the network element.

22. The apparatus of claim 21, wherein receiving at least one primitive comprises receiving the at least one primitive from a source network element as a pass through from an element management system.

23. The apparatus of claim 21, wherein receiving at least one primitive comprises receiving a set of primitives that define an interface between a power management application running on an element management system and the line power controller.

24. The apparatus of claim 21, wherein receiving at least one primitive comprises a set of primitives that define an interface between the line power controller and the at least one line power control function.

25. The apparatus of claim 21, wherein selectively taking action comprises invoking one or more power save and protection switching functions.

26. The apparatus of claim 21, wherein provisioning at least one conductive medium with the at least one instance of the line power controller comprises associating at least one conductive medium that also transports communication signals.

27. The apparatus of claim 21, wherein provisioning at least one conductive medium with the at least one instance of the line power controller comprises associating at least one conductive medium with at least one media interface.

28. A method for controlling a line-powered network element in an access network, the method comprising:
provisioning at least one instance of a line power controller at the line-powered network element;
provisioning at least one conductive medium associated with the at least one instance of the line power controller;
receiving at least one primitive for use by the line power controller for managing the line-powered network element;
monitoring at least one of the at least one primitive; and
selectively taking action through the at least one line power controller based on the monitored ones of the at least one primitive in response to power conditions for the line-powered network element.

29. The method of claim 28, wherein receiving at least one primitive comprises receiving a plurality of primitives associated with a power profile for a selected service.

30. The method of claim 28, further including storing the received primitives in a database associated with the line-powered network element.

31. The method of claim 30, wherein storing the received primitives comprises:
generating an identification for the instance of the line power controller; and
storing the primitives in association with the identification in a database.

32. The method of claim 28, wherein receiving at least one primitive comprises receiving at least one of a control primitive, an alarm primitive and a monitoring primitive.

33. The method of claim 28, further including outputting data using one of the at least one primitive.

34. The method of claim 33, wherein outputting data comprises outputting an alarm or condition to one of a craft port and a remote monitoring station.

35. The apparatus of claim 28, wherein provisioning at least one conductive medium with the at least one instance of the line power controller comprises associating at least one conductive medium that also transports communication signals.

36. The apparatus of claim 28, wherein provisioning at least one conductive medium with the at least one instance of the line power controller comprises associating at least one conductive medium with at least one media interface.

37. A method for controlling a sink network element in an access network, the sink network element subtended from a source network element, the method comprising:
provisioning at least one instance of a line power controller at the sink network element and an associated line power controller at the source network element;
provisioning at least one conductive medium associated with the at least one instance of the line power controller at each of the source and sink network elements;
receiving at least one primitive for use by the line power controller at the sink network element and at least one primitive for use by the line power controller at the source network element;
monitoring at least one of the at least one primitives at each of the source network element and the sink network element; and
selectively taking action at each of the source network element and the sink network element through their respective at least one line power controller based on the monitored ones of the at least one primitive in response to power conditions for the source network element and the sink network element.

38. The method of claim 37, wherein receiving at least one primitive comprises:
receiving a plurality of primitives at the source network element from an element management system;
selecting primitives associated with the source network element from the plurality of primitives received at the source network element;
storing the selected primitives in a database associated with the source network element;
passing through the remaining of the plurality of primitives to the sink network element; and
storing the remaining plurality of primitives in a database associated with the sink network element.

39. The method of claim 37, wherein provisioning at least one conductive medium with the at least one instance of the line power controller comprises associating at least one conductive medium that also transports communication signals.

40. The method of claim 37, wherein provisioning at least one conductive medium with the at least one instance of the line power controller comprises associating at least one conductive medium with at least one media interface.
